(19) United States
(12) Patent Application Publication
(10) Pub. No.: US 2015/0117823 A1
(43) Pub. Date: Apr. 30, 2015

(54) Fiber Connector Assembly

(71) Applicants: Georgios Panotopoulos, Berkeley, CA (US); Michael Renne Ty Tan, Menlo Park, CA (US); Paul Kessler Roserberg, Sunnyvale, CA (US); Wayne Victor Sorin, Mountain View, CA (US); Sagi Varghese Mathai, Sunnyvale, CA (US); Susant K. Patra, Palo Alto, CA (US)

(72) Inventors: Georgios Panotopoulos, Berkeley, CA (US); Michael Renne Ty Tan, Menlo Park, CA (US); Paul Kessler Roserberg, Sunnyvale, CA (US); Wayne Victor Sorin, Mountain View, CA (US); Sagi Varghese Mathai, Sunnyvale, CA (US); Susant K. Patra, Palo Alto, CA (US)

(21) Appl. No.: 14/396,055

(22) PCT Filed: May 24, 2012
(86) PCT No.: PCT/US12/39356

§ 371 Date: Oct. 21, 2014

(51) Int. Cl. G02B 6/293

(52) U.S. Cl. CPC G02B 6/293
USPC 385/89

(57) ABSTRACT

A fiber connector assembly is provided. The fiber connector assembly includes a fiber connector, a zig-zag member, a signal direction element, and a signal splitting element. The fiber connector receives an input signal from an input fiber. The zig-zag member relays the input signal using a plurality of relay mirrors. The signal direction element directs the input signal and the output signal. The signal splitting element separates the output signal from the input signal. The fiber connector couples the output signal to an output fiber.

### BACKGROUND

Optical devices use connectors to receive input signals and emit output signals. The connectors and mechanical features associated therewith add to the cost and complexity of optical devices.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 illustrates a block diagram of a system to split signals according to an example;

FIGS. 2-3 illustrate a schematic diagram of the system of FIG. 1 according to examples;

FIG. 4 illustrates a block diagram of a fiber connector assembly according to an example;

FIG. 5 illustrates a schematic diagram of the fiber connector assembly of FIG. 4 according to an example; and

FIG. 6 illustrates a flow chart of a method to split signals using a fiber connector assembly according to an example.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure.

Optical devices typically use separate input and output connectors. For example, where separate input and output connectors are used, the connectors are positioned facing one another, at a ninety-degree angle, and/or in another precise configuration to ensure appropriate signal coupling. Separate input and output connectors increase the cost and complexity of the optical device. The connectors may include lens arrays attached and/or manufactured thereon to reduce costs; however, separate input and output connectors comprise a large percentage of the cost of the optical device.

In examples, a fiber connector assembly is provided. The fiber connector assembly includes a fiber connector, a zigzag member, a signal direction element, and a signal splitting element. The fiber connector receives an input signal from an input fiber. The zigzag member relays the input signal using a plurality of relay mirrors. The signal direction element directs the input signal and the output signal. The signal splitting element separates the output signal from the input signal. The fiber connector couples the output signal to an output fiber.

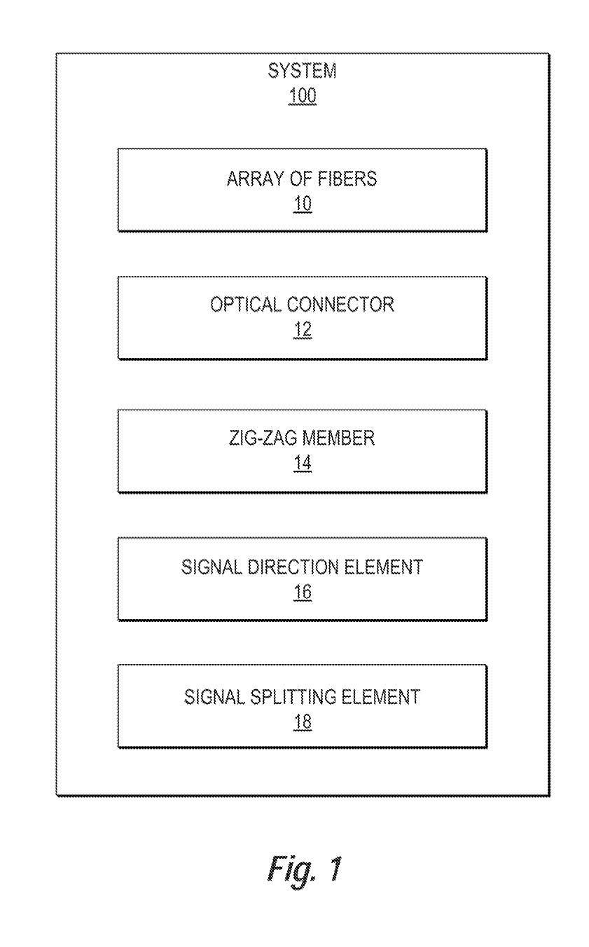

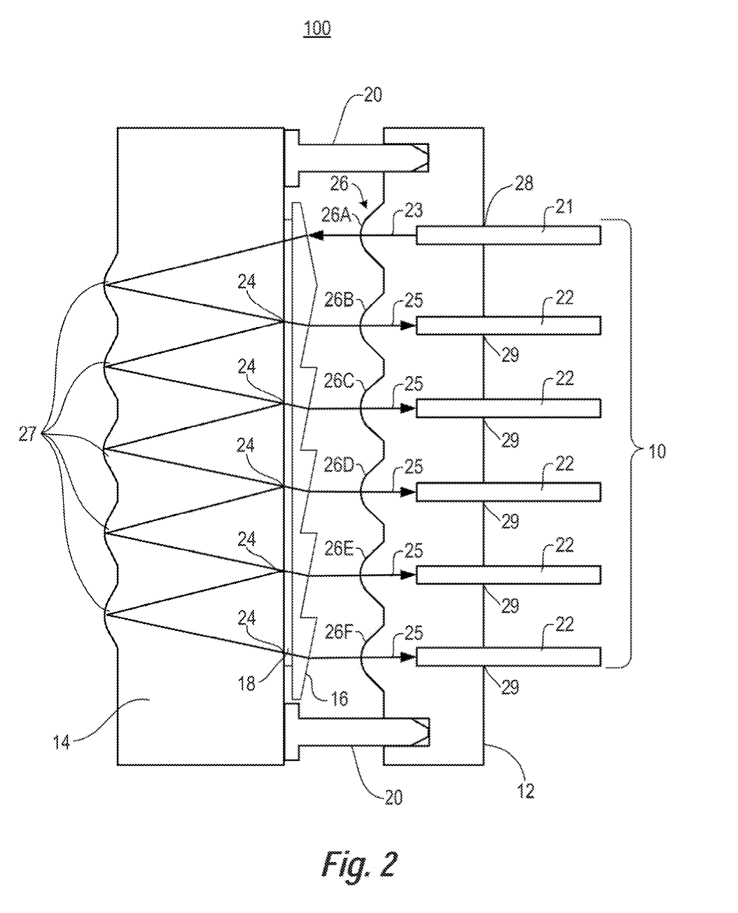

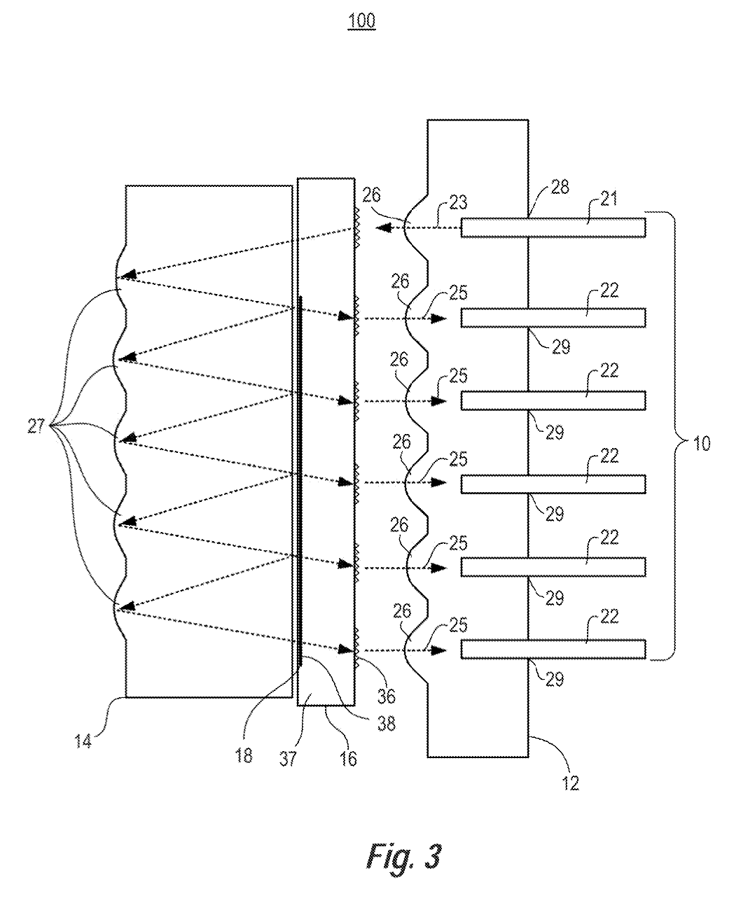

FIG. 1 illustrates a block diagram of a system 100 to split optical power according to an example. The system 100 includes an array of fibers 10, a fiber connector 12, a zig-zag member 14, a signal direction element 16, and a signal splitting element 18. The system 100 splits the optical power using a zig-zag architecture that uses a single fiber connector for the input and the output of the signals, such that signals enter and leave the zig-zag member 14 via the same side. Schematic views of the system of FIG. 1 according to examples are further illustrated in FIGS. 2-3.

Referring to FIGS. 1-3, the array of fibers 10 include an input fiber 21 and a plurality of output fibers 22. For example, the array of fibers 10 may include an M by N array of fibers, where the top row (row 1) includes M (columns of) input fibers 21 and the remaining N−1 rows each include M output fibers. The input fiber 21 includes an input signal 23 with at least one wavelength 24. Each of the plurality of output fibers 22 receives an output signal 25 for the at least one wavelength 24. The array of fibers 10 are connected to or mounted on the fiber connector 12. The array of fibers 10, including both the input fiber 21 and the plurality of output fibers 22. The distance between the input fiber 21 and each of the plurality of output fibers 22 are arranged to be greater than the pitch of the corresponding output fiber 22.

The fiber connector 12 further includes an input element 28 that receives and/or collimates the input signal 23 from the input fiber 21. The fiber connector 12 further includes an output element 29 that receives the output signals 25 and couples the output signals 25 to the plurality of output fibers 22 associated therewith. For example, the input and output elements 28, 29 include an opening in the fiber connector 12, such as a drilled hole, where the fibers of the array of fibers 10 are inserted into.

The fiber connector 12 includes a plurality of fiber lenses 26 arranged such that each of the plurality of fiber lenses 26 corresponds to one fiber in the array of fibers 10. The fiber lenses 26 include lenses that are built into or attached to the fiber connector 12. The fiber lenses 26 may also not include lenses, but instead include a lenslet array attached to the fiber connector 12 or implemented on the signal direction element 16.

The array of fibers 10 are mounted on the fiber connector 12 and aligned to the corresponding plurality of fiber lenses 26, such as an M by N array of fiber lenses. The top row is illustrated as corresponding to the input fiber 21 (e.g. lens 26A of FIG. 2) that couples the input signal 23 emanating from the input fiber 21 into the zig-zag member 14. The remaining rows, illustrated as corresponding to the plurality of output fibers 22 (e.g. lenses 26B-F of FIG. 2) that couple the output signal 25 emanating from the zig-zag member 14 to the corresponding output fibers 22. Note that the same fiber connector 12 is used for both the input signals 23 and the output signals 25.

The zig-zag member 14 is connected to the fiber connector 12 to relay the input signal 23. The zig-zag member 14 includes a plurality of relay mirrors 27 to reflect the input signal 23. As illustrated in FIGS. 2-3, the side of the zig-zag member 14 furthest from the fiber connector 12 includes the relay mirrors 27 at locations corresponding to the incident light. The relay mirrors 27 act as powered mirrors that maintain light beam collimation for each of the wavelengths 24.

The relay mirrors 27 may include a mirror or a reflective coating. The mirror may be a dielectric mirror or a metallic mirror, such as a mirror formed of gold (AU) or silver (AG). For example, relay mirrors 27 that include a reflective coating have a reflectivity value of approximately one hundred percent. The reflective coating maintains a collimation of the output signals 25, such that the signals can be relayed to successive output fibers 22. Each of the plurality of relay mirrors 27 correspond to at least one output fiber 22 of the array of fibers 10. For example, each relay mirror 27 may correspond to a distinct output fiber 22, or one or more of the relay mirrors 27 may correspond to a plurality of output fibers 22.

The signal direction element 16 is between the fiber connector 12 and the zig-zag member 14. The signal direction element 16 directs the input signal 23 and the output signal 25. The signal direction element directs the input signal 23 such that the input signal 23 is collimated and directed towards the zig-zag member 14 and bounces appropriately in the zig-zag member 14. For example, the input signal 23 is tilted towards the plurality of relay mirrors 27. The signal direction element 16 also directs each output signal 25 from the zig-zag member 14 towards the fiber connector 12 to couple the output signals 25 thereto.

For example, the signal direction element 16 may correct the angle of the output signal 25 to ensure each of the output signals 25 are coupled to corresponding output fibers 22. The position of the relay mirrors 27 and the fiber lenses 26 will be effected by the thickness of the signal direction element 16. Appropriate modification to the position of the relay mirrors 27 and fiber lenses 26 may be required as the thickness of the signal direction element 16 changes.

FIGS. 2-3 each illustrate an example of a signal direction element 16. Referring to FIG. 2, the signal direction element 16 is illustrated as a linear prism array. The linear prism array may be embossed on adhesive film, embossed on a plastic wafer, or etched on glass wafer. The linear prism array may be a refractive prism that aligns both input signals 23 and output signals 25. The linear prism array is useable with for example, a coarse wavelength-division multiplexing (CWDM) demultiplexer.

Referring to FIG. 3, another example of the signal direction element 16 is provided. The signal direction element 16 is a grating, such as a high contrast grating and/or a diffractive grating. Gratings are typically used for power splitting, such as the broadcast of an optical signal to clients and each client receives a copy of the exact signal. FIG. 3 illustrates the signal direction element 16 as diffractive gratings 36. The diffractive gratings 36 may be high contrast gratings (HCG) to improve diffraction efficiency. The spatial features of the gratings can have various shapes to increase efficiency and reduce polarization dependence. The diffractive gratings 36 are positioned on a grating substrate 37. The thickness of the grating substrate 37 in the figure is exaggerated and could be much thinner.

Referring back to FIGS. 1-3, the signal splitting element 18 is illustrated. The signal splitting element 18 separates the output signal 25 from the input signal 23. The signal splitting element 18 may be a separate element and/or a coating applied to at least one of the signal direction element 16 and the zig-zag member 14.

FIG. 2 illustrates the signal splitting element 18 as a separate element or member that is connected to the zig-zag member 14 and the signal direction element 16. The signal splitting element 18 includes, for example, a plurality of filters, such as band-pass filters. Each filter corresponds to the at least one wavelength 24, such that the filter only allows one wavelengths 24 from the input signal 23 to pass through and provide the output signal 25. For example, the filters may be positioned to correspond to each of the fiber lenses 26, such that only the wavelength corresponding to each particular fiber lens 26 passes therethrough to separate the output signals 25. The filter is an example of a signal splitting element 18 useable with a CWDM demultiplexer.

FIG. 3 illustrates the signal splitting element 18 as a linear array of partial reflectors useable with, for example, a power splitter. The linear array of partial reflectors provides the same power to each output signal. For example, the array of partial reflectors is arranged such that each of the partial reflectors has a reflectivity value that provides the same power to each of the output signals 25. For example, the top row of reflectors (i.e., the reflector corresponding to fiber lens 26A of FIG. 2) have zero reflectivity and the bottom row of reflectors (i.e., the reflector corresponding to fiber lens 26F of FIG. 2) also have zero reflectivity. The remaining reflectors therebetween (i.e., the reflectors corresponding to fiber lenses 26B-E of FIG. 2) have reflectivity values of ⅘, ¾, ⅔, and ½, such that the signals coupled through each of the fiber lenses (i.e., the reflectors corresponding to fiber lenses 26B to 26F of FIG. 2) have the same power.

The array of partial reflectors is deposited on, for example, a glass wafer. The array of partial reflectors may further implemented with fewer reflector values to reduce costs. The array of partial reflectors is illustrated as a coating in FIG. 3, such as a reflective coating for a power splitter. The coating is illustrated as applied to the signal direction element 16, but alternatively may be applied to the zig-zag member 14. In examples where the signal splitting element 18 is a coating 38, the coating 38 may be formed of dielectric films.

The fiber connector 12, the zig-zag member 14, and the signal direction element 16 may be fabricated as molded wafers that may be aligned actively, passively with mechanical mating features, and/or using machine vision. The elements may be attached using, for example, glue, wafer bonding, and/or an interlocking mechanism. Furthermore, any coatings applied, may be applied on standard semiconductor wafer processing tools.

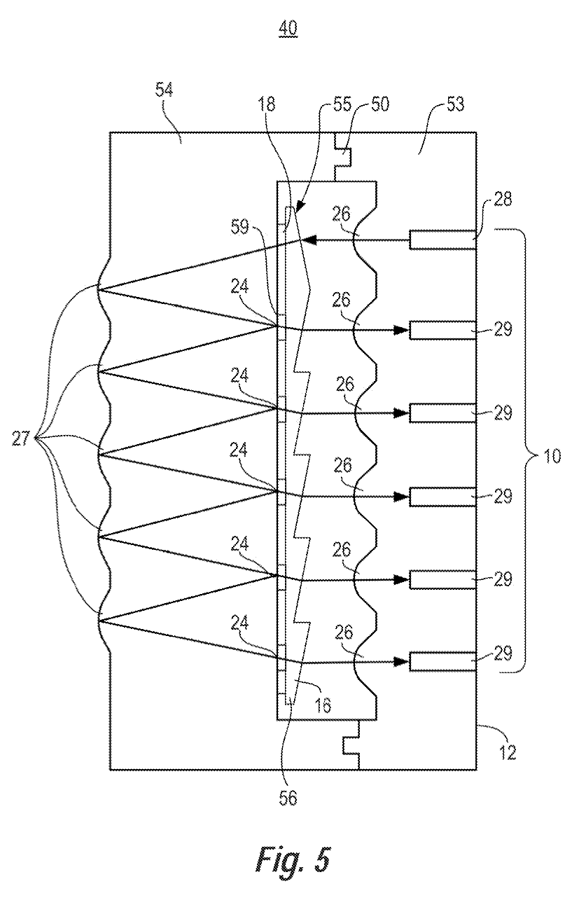

The system 100 may further include a connector member 20, an example of which is illustrated in FIG. 2. The connector member 20 aligns and/or connects the zig-zag member 14 and the fiber connector 12. The connector member 20 may be formed as a separate member that connects the zig-zag member 14 and the fiber connector 12, as illustrated in FIG. 2. Alternatively, the zig-zag member 14 and the fiber connector 12 may be directly connected to one another, as illustrated below in FIG. 5, using a method, such as wafer bonding. Where the zig-zag member and the fiber connector 12 are directly connected, deep reactive ion etching (DRIE), electroplating metal (e.g., nickel), or metal sheet stamping may be used to define or produce the mechanical features used for alignment.

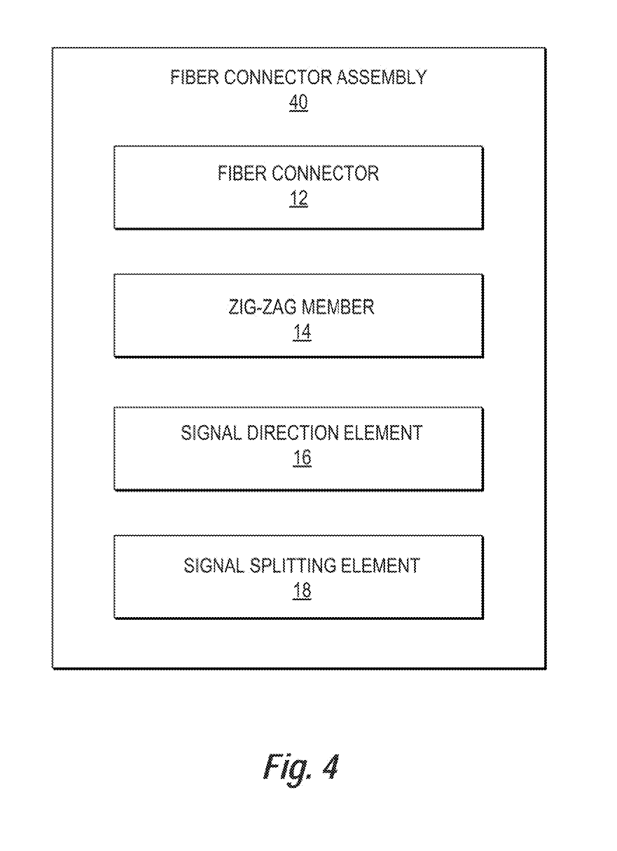

FIG. 4 illustrates block diagram of a fiber connector assembly 40 according to an example. FIG. 5 illustrates a schematic diagram of the fiber connector assembly 40 of FIG. 4 according to an example. For example, the fiber connector 12 may be a power splitter or a coarse wavelength-division multiplexing (CWDM) demultiplexer. The fiber connector assembly 40 includes a fiber connector 12, a zig-zag member 14, a signal direction element 16, and a signal splitting element 18.

Referring to FIGS. 4-5, the fiber connector 12 is an input and output connector formed of, for example, a molded wafer. The fiber connector 12 includes an input element 28 and an output element 29. The input element 28 receives an input signal 23 from an input fiber 21. The output element 29 receives the at least one output signal 25 and couples each of the output signals 25 to the plurality of output fibers 22 (illustrated in FIG. 2) associated therewith. The same fiber connector 12 connects the input element 28 and the output element 29 to the array of fibers 10. For example, the input and output elements 28, 29 may be connected to the fiber connector 12 formed of a plastic molded wafer, such that the input element 28 connects to the input fiber 21 and the output element connects to the output fiber 22.

As described with reference to FIG. 2, the array of fibers 10 includes both the input fiber 21 and the plurality of output fibers 22. For example, input signal 23 may be received from the array of fibers 10, such as an M by N array of fibers, where the top row (row 1) includes M (columns of) input fibers 21 and the remaining N−1 rows each include M output fibers. The input fiber 21 includes the input signal 23 with at least one wavelength 24. Each of the plurality of output fibers 22 receives an output signal 25 for the at least one wavelength 24. The input element 28 and the output elements 29 are arranged such that the distance between the input fiber 21 and each of the plurality of output fibers 22 are greater than the pitch of the corresponding output fiber 22.

Referring back to FIG. 5, the fiber connector 12 may further include a plurality of fiber lenses 26, such as an array of fiber lenses that receive and/or collimate the input signal 23 from the input element 28, receive and/or collimate the at least one output signal 25 from the signal direction element 16, and couple the at least one output signal 25 to the output element 29. The fiber lenses 26 include lenses that are built into or attached to the fiber connector 12. The fiber lenses 26 may include, for example, single lenses or a lenslet array. For example, the lenslet array may be attached to the fiber connector 12 or implemented on the signal direction element 16. The plurality of fiber lenses 26 are arranged such that each of the plurality of fiber lenses 26 corresponds to one fiber in the array of fibers 10, as illustrated in FIGS. 2-3. As described with reference to FIGS. 1-3, the array of fibers 10 are mounted and aligned to the corresponding plurality of fiber lenses 26, such as an M by N array of fiber lenses. The top row is illustrated as corresponding to the input fiber 21 (e.g. lens 26A of FIG. 2) that couples the input signal 23 emanating from the input fiber 21 into the zig-zag member 14. The remaining rows, illustrated as corresponding to the plurality of output fibers 22 (e.g. lenses 26B-F of FIG. 2) that couple the output signal 25 emanating from the zig-zag member 14 to the corresponding output fibers 22.

The input signal 23 that emanates from the input element 28 is collimated to the zig-zag member 14. The zig-zag member 14 relays the input signal 23 using a plurality of relay mirrors. The plurality of relay mirrors 27 reflect at least one of the wavelengths 24 of the input signal 23. Each of the plurality of relay mirrors 27 correspond to at least one fiber of the array of fibers 10. As illustrated in FIG. 5, the side of the zig-zag member 14 furthest from the input element 28 and the output elements 29 includes relay mirrors 27 at locations corresponding to the incident light. The relay mirrors 27 may include a reflective coating that maintains the output signals 25, such that the signals can be relayed to successive output fibers 22. For example, the relay mirrors 27 act as powered mirrors that maintain light beam collimation for each of the wavelengths 24. The zig-zag member 14 is connected to the output elements 29 to relay each output signal 25 to one of the plurality of output fibers 22.

The signal direction element 16 is between the input and output elements 28, 29 and the zig-zag member 14. The signal direction element 16 directs the input signal 23 from the input element 28 toward the zig-zag member 14 and directs the at least one output signal 25 toward the output element 29 corresponding thereto. For example, the signal direction element 16 tilts the input signal 23 from the input element 28 such that the input signal 23 is directed towards the plurality of relay mirrors 28 of the zig-zag member 14 and bounces appropriately in the zig-zag member 14. The signal direction element 16 also directs each output signal 25 from the zig-zag member 14 to couple the output signals 25 with the fiber connector 12. For example, the signal direction element 16 may correct the angle of the output signal 25 to ensure each of the output signals 25 are coupled to corresponding output fibers 22. The signal direction element 16 may include, for example, a linear prism, a high contrast grating, or a diffractive grating.

FIG. 5 illustrates the signal direction element 16 as a linear prism array 56, useable with, for example, a CWDM demultiplexer. The linear prism array 56 may be a refractive prism that aligns both input signals 23 and output signals 25. The linear prism array 56 may be embossed on adhesive film, embossed on a plastic wafer, or etched on glass wafer. The thickness of the signal direction element 16 will effect the position of the relay mirrors 27 and the fiber lenses 26 with respect to one another and appropriate modification thereto may be required as the thickness of the signal direction element 16 changes. The signal splitting element 18 separates at least one output signal 25 from the input signal 23, using, for example, an array of partial reflectors, a filter, and/or a coating.

Referring to FIG. 5, the signal splitting element 18 is illustrated as a separate member that is connected to the zig-zag member 14 and the signal direction element 16. In a power sputter, for example, the signal splitting element 18 may include an array of partial reflectors are deposited on, for example a glass wafer. The array of partial reflectors arranged such that each of the partial reflectors has a reflectivity value that provides the same power to each of the output signals 25. Referring back to the array of partial reflectors of FIG. 3, the top row of reflectors (i.e., the reflector corresponding to fiber lens 26A of FIG. 2) that have zero reflectivity and the bottom row of reflectors (i.e., the reflector corresponding to fiber lens 26F) that also have zero reflectivity. The remaining reflectors therebetween, (i.e., the reflectors corresponding to fiber lenses 26C-E of FIG. 2) have reflectivity values of ⅘, ¾, ⅔, and ½, such that the signals coupled to the reflector lenses 27 of the zig-zag member 14 have the same power. The array of partial reflectors may further implemented with fewer reflector values to reduce costs.

The signal splitting element 18 may alternatively include a filter, instead of the array of partial reflectors. The signal splitting element may include a filter to separate at least one wavelength 24 from the input signal 23 to provide the at least one output signal 25. For example, in a CWDM demultiplexer the filter corresponds the wavelengths 24 of the at least one output signal 25, such that each wavelength 24 that is filtered from the input signal 23 is coupled to an output element 29. An example of a filter is a band-pass filter that corresponds to the wavelengths 24 from the input signal 23.

Moreover, the signal splitting element 18 may be a coating applied to at least one of the signal direction element 16 and the zig-zag member 14. The coating may function similar to the array of reflector and/or the filters depending on the fiber connector assembly 40.

Referring back to FIG. 5, the fiber connector assembly 40 may be assembled from a fiber connector 12 formed of a molded wafer or plastic molded wafer 53. The zig-zag member 14 and the signal direction element 16 may also be formed of a molded wafer or plastic molded wafer 54, 55.

The zig-zag member 14 and the fiber connector 12 may be aligned and/or connected using connector members, such as a separate connector 20, as illustrated in FIG. 2 or connecting the zig-zag member 14 to the fiber connector 12 using mating features 50, as illustrated in FIG. 5. The mating features 50 align the fiber lenses 26 of the fiber connector 12 and the relay mirrors 27 of the zig-zag member 15. The mating features 50 may be directly connected to one another using a method, such as wafer bonding. The mating features 50 may be formed using deep reactive ion etching (DRIE), electroplating metal (e.g., nickel), or metal sheet stamping.

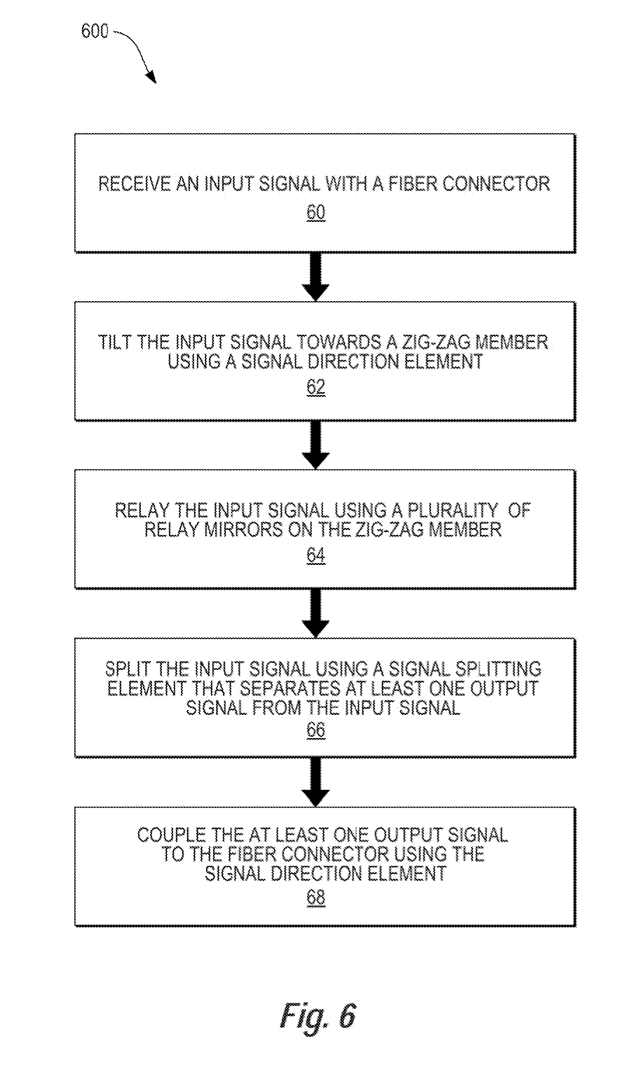

FIG. 6 illustrates a flow chart 600 of a method to split signals using a fiber connector assembly according to an example. In block 60, an input signal is received with the fiber connector assembly. The fiber connector assembly includes a fiber connector with an input element and an output element. The fiber connector collimates the input signal using, for example, the input element. In block 62, the input signal is tilted towards a zig-zag member using a signal direction element. For example, the signal direction element is a linear prism array or a diffractive grating array. The input signal is relayed using a plurality of relay mirrors on the zig-zag in block 64. The input signal is split in block 66 using a signal splitting element that separates at least one output signal from the input signal. In block 68, at least one output signal is coupled to the fiber connector using the signal direction element. For example, the output signal may be coupled to the output element of the fiber connector.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be exemplary. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. A system to split signals using a fiber connector assembly, the system comprising:
an array of fibers including:
an input fiber with an input signal, the input signal including at least one wavelength, and
a plurality of output fibers, each of the plurality of output fibers to receive an output signal for the at least one wavelength;
a fiber connector connected to the array of fibers, the fiber connector including a plurality of fiber lenses arranged such that each of the plurality of fiber lenses corresponds to one fiber in the array of fibers;
a zig-zag member connected to the fiber connector to relay the input signal, the zig-zag member includes a plurality of relay mirrors to reflect the input signal, each of the plurality of relay mirrors correspond to at least one of the plurality of output fibers;
a signal direction element between the fiber connector and the zig-zag member to direct the input signal and the output signal such that,
the input signal is tilted towards the zig-zag member, and
the output signal is coupled to one of the plurality of output fibers; and
a signal splitting element to separate the output signal from the input signal.

2. The system of claim 1, further comprising a connector member to align the zig-zag member and the fiber connector.

3. The system of claim 1, wherein the fiber connector further comprises:
an input element to receive the input signal from the input fiber; and
an output element to receive the output signals and couple each of the output signals to the plurality of output fibers associated therewith.

4. The system of claim 1, wherein the signal splitting element comprises a linear array of partial reflectors that provide the same power to each output signal.

5. The system of claim 1, wherein the signal splitting element comprises a coating applied to at least one of the signal direction element and the zigzag member.

6. The system of claim 1, wherein the signal splitting element comprises a band-pass filter corresponding to the at least one wavelength from the input signal to provide the output signal.

7. The system of claim 1, wherein the signal direction element comprises at least one of a linear prism, a high contrast grating, and a diffractive grating.

8. A fiber connector assembly comprising:
a fiber connector including an input element and an output element, the input element to receive an input signal from an input fiber, the output element to receive at least one output signal and couples the at least one output signal to an output fiber;
a zig-zag member to relay the input signal, the zig-zag member includes a plurality of relay mirrors to reflect the input signal;
a signal splitting element to separate the at least one output signal from the input signal; and
a signal direction element between the zig-zag member and the output element to direct the input signal toward the zig-zag member and direct the at least one output signal toward the output element corresponding thereto.

9. The fiber connector assembly of claim 8, further comprising an array of fiber lenses to:
receive the input signal from the input element;
receive the at least one output signal from the signal direction element; and
couple the at east one output signal to the output element.

10. The fiber connector assembly of claim 8, wherein the signal direction element the input signal to direct the input signal towards the plurality of relay mirrors.

11. The fiber connector assembly of claim 8, wherein the signal direction element comprises at least one of a linear prism, a high contrast grating, and a diffractive grating.

12. The fiber connector assembly of claim 8, wherein the signal splitting element comprises a coating applied to at least one of the signal direction element and the zig-zag member.

13. The fiber connector assembly of claim 8, wherein the signal splitting element comprises a band-pass filter to separate at least one wavelength from the input signal to provide the at least one output signal.

14. The fiber connector assembly of claim 7, wherein the signal splitting element comprises an array of partial reflectors arranged such that each of the plurality of reflectors has a reflectivity value that provides the same power to each of the at least one output signal.

15. A method to split signals using a fiber connector assembly, the method comprising:
receiving an input signal with the fiber connector assembly, the fiber connector assembly including a fiber connector to collimate the input signal;
tilting the input signal towards a zig-zag member using a signal direction element;
relaying the input signal using a plurality of relay mirrors on the zig-zag member;
splitting the input signal using a signal splitting element that separates at least one output signal from the input signal; and
coupling the at least one output signal to the fiber connector using the signal direction element.
